(19) United States
(12) Patent Application Publication
(10) Pub. No.: US 2010/0005118 A1
(43) Pub. Date: Jan. 7, 2010

(54) Detection of Patterns

(76) Inventor: Sakir Sezer, Belfast (GB)

Correspondence Address: CHOATE, HALL & STEWART LLP, TWO INTERNATIONAL PLACE, BOSTON, MA, 02110, US

(21) Appl. No.: 12/444,346

(22) PCT Filed: Oct. 10, 2007
(86) PCT No.: PCT/GB2007/003833

§ 371 Date: May 15, 2009

(30) Foreign Application Priority Data
Oct. 10, 2006 (GB) 0620043.0

(51) Int. Cl. G06F 17/00

(52) U.S. Cl. 707/104.1; 707/100; 707/E17.001

(57) ABSTRACT

A method of detecting patterns in a plurality of data blocks, comprising generating a first database comprising a first subset of patterns of a set of selected patterns, generating a second database comprising a second subset of remaining patterns of the set of selected patterns, receiving the plurality of data blocks, and, for each data block, using the data, block and a hash function to generate a key, using the key to search the first database, locating an entry of the first database corresponding to the key, reading the content of the entry which comprises zero or a selected pattern that generates the key, if the content of the entry comprises zero, determining that the data block does not comprise a selected pattern, and outputting a first output indicating that the data block does not comprise a selected pattern.

The invention relates to the detection of patterns.

There are many applications where the ability to detect patterns in information is desirable. These include string matching where a specific pattern or string is selected and information is searched for a matching pattern or string. This has application in numerous fields, for example document searching, records searching, security (where for example a data or voice message may be searched for a pattern comprising a particular word or words or sequence of words). Other applications where pattern detection is used include biological applications such as DNA sequencing, and various applications in the telecommunications industry, such as regular expression processing, IP packet classification and deep packet inspection. In the latter application, the packets may be inspected for e.g. the presence of patterns found in malicious content such as viruses or worms.

The applications of pattern detection are so widespread, that improvements in the detection, for example the speed of detection, are constantly being sought.

According to a first aspect of the invention there is provided a method of detecting patterns in a plurality of data blocks, comprising generating a first database comprising a first subset of patterns of a set of selected patterns,

generating a second database comprising a second subset of remaining patterns of the set of selected patterns,

receiving the plurality of data blocks, and, for each data block, using the data block and a hash function to generate a key,

using the key to search the first database,

locating an entry of the first database corresponding to the key,

reading the content of the entry which comprises zero or a selected pattern that generates the key,

if the content of the entry comprises zero, determining that the data block does not comprise a selected pattern, and outputting a first output indicating that the data block does not comprise a selected pattern, or if the content of the entry comprises a selected pattern, determining that the data block comprises the selected pattern and outputting a first output indicating that the data block comprises the selected pattern, or

determining that the data block does not comprise the selected pattern and outputting a first output indicating that the data block does not comprise the selected pattern, and

using a content addressable memory (CAM) to compare the data block with the second database,

determining that the data block matches a selected pattern in the second database, and outputting a second output indicating that the data block comprises the selected pattern, or

determining that the data block does not match a selected pattern in the second database, and outputting a second output indicating that the data block does not comprise a selected pattern,

combining the first and second outputs, and if either output indicates that the data block comprises a selected pattern, outputting a flag indicating that the data block comprises the selected pattern.

Generating the first database comprising the first subset of patterns of a set of selected patterns, may comprise determining each possible data block, using each possible data block and the hash function to generate a plurality of keys, comparing the or each data block which generates a key with the set of selected patterns, and if the or each data block does not comprise a selected pattern, generating an entry of the first database comprising the key and zero, or if the or any of the data blocks does comprise a selected pattern, generating an entry of the first database comprising the key, the or one of the data blocks which comprises a selected pattern and an identifier (ID) for the data block.

Generating the second database comprising the second subset of remaining patterns of a set of selected patterns, may comprise generating an entry of the second database comprising each of the data blocks which comprises a selected pattern not stored in an entry of the first database.

Generating the key may comprise generating a key which is compressed with respect to the data block. Generating a compressed key results in reduced memory requirements.

Determining that the data block comprises or does not comprise a selected pattern may comprise comparing the data block with the selected pattern to determine if a match between them does or does not occur.

Combining the first and second outputs may comprise multiplexing the outputs.

The method may be used to detect patterns starting at any position of a data block. The method may be used to detect selected patterns having various lengths.

According to a second aspect of the invention there is provided a pattern detection circuit for detecting patterns in a plurality of data blocks, comprising

a plurality of hash modules, each hash module comprising a first database comprising a first subset of patterns of a set of selected patterns, wherein each hash module receives the plurality of data blocks, and, for each data block,

uses the data block and a hash function to generate a key,

uses the key to search the first database,

locates an entry of the first database corresponding to the key,

reads the content of the entry which comprises zero or a selected pattern that generates the key,

if the content of the entry comprises zero, determines that the data block does not comprise a selected pattern, and outputs a first output indicating that the data block does not comprise a selected pattern, or

if the content of the entry comprises a selected pattern, determines that the data block comprises the selected pattern and outputs a first output indicating that the data block comprises the selected pattern, or

determines that the data block does not comprise the selected pattern and outputs a first output indicating that the data block does not comprise the selected pattern, and

a plurality of CAM modules, each CAM module comprising a second database comprising a second subset of remaining patterns of the set of selected patterns,

wherein each CAM module receives the plurality of data blocks, and, for each data block,

compares the data block with the second database,

determines that the data block matches a selected pattern in the second database, and outputs a second output indicating that the data block comprises the selected pattern, or

determines that the data block does not match a selected pattern in the second database, and outputs a second output indicating that the data block does not comprise a selected pattern, and

a combiner module which combines the first and second outputs, and if either output indicates that the data block comprises a selected pattern, outputs a flag indicating that the data block comprises the selected pattern.

Each hash module may comprise a RAM device. Each RAM device may store the first database. A key may be used to search the first database of a RAM device by using the key as an address to search addresses assigned to a plurality of memory locations of the RAM device.

Each hash module may comprise a plurality of hash devices each of which uses a data block and the hash function to generate a key.

Each CAM module may comprise a plurality of CAM cells. Each CAM cell may store a data block comprising a pattern of the second database. Each CAM cell may comprise a plurality of comparators each of which compares a received data block with the data block stored in the CAM cell.

The combiner module may comprise a multiplexer.

The pattern detection circuit may detect a pattern starting at any position of a data block. The pattern detection circuit may comprise a plurality of hash devices and a plurality of CAM comparators, a first data block may be input into a first hash device and into a first CAM comparator, a second data block, shifted with respect to the first data block, may be input into a second hash device and into a second CAM comparator and so on. The second data block may be shifted by one or more positions of the block with respect to the first data block. For example, the first and second data blocks may comprise bits or bytes, and the second data block may be shifted by one or more positions comprising one or more bits or bytes of the block with respect to the first data block. This allows detection of a pattern starting at any position in the data blocks.

The pattern detection circuit may comprise a plurality of parts, a first part which detects patterns of length n, a second part which detects patterns of length n−1, a third part which detects patterns of length n−2, and so on.

The selected patterns will comprise a plurality of patterns whose presence in the data blocks it is wished to detect. The selected patterns may comprise any of whole or partial words or whole or partial strings or whole or partial DNA sequences or signatures or signature segments of malicious content.

It will be understood that the term pattern is used to describe any character or number of characters, and is not to be limited in meaning to a number of characters having a repetitive nature.

An embodiment of the invention will now be described, by way of example only, with reference to the accompanying drawings, in which:

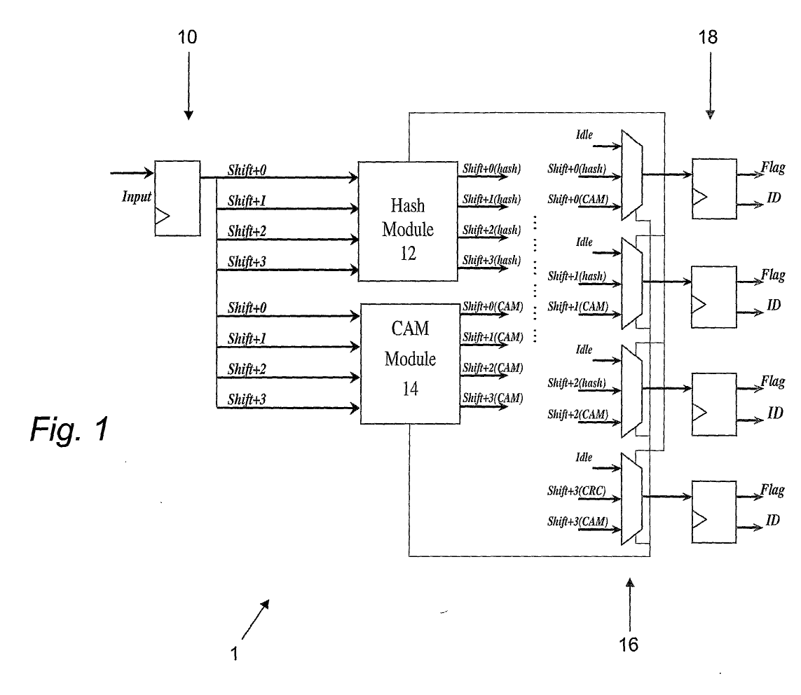

FIG. 1 is a schematic representation of a pattern detection circuit according to the invention, comprising a hash module and a CAM module,

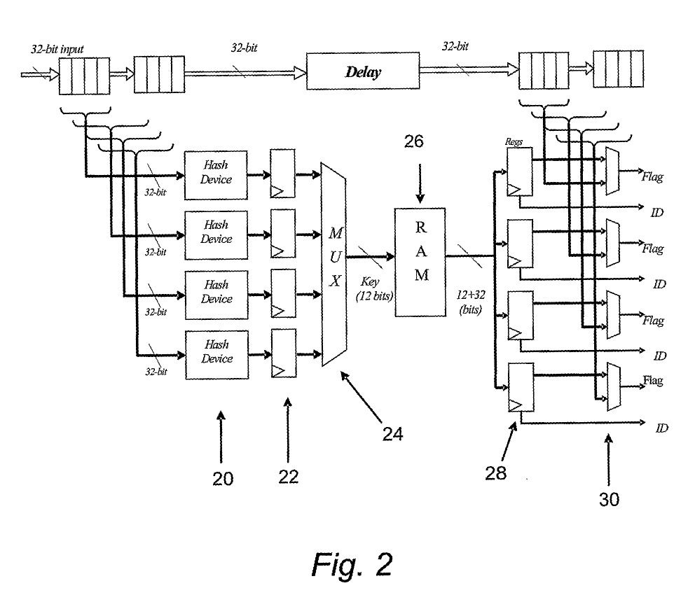

FIG. 2 is a schematic representation of part of the hash module of FIG. 1,

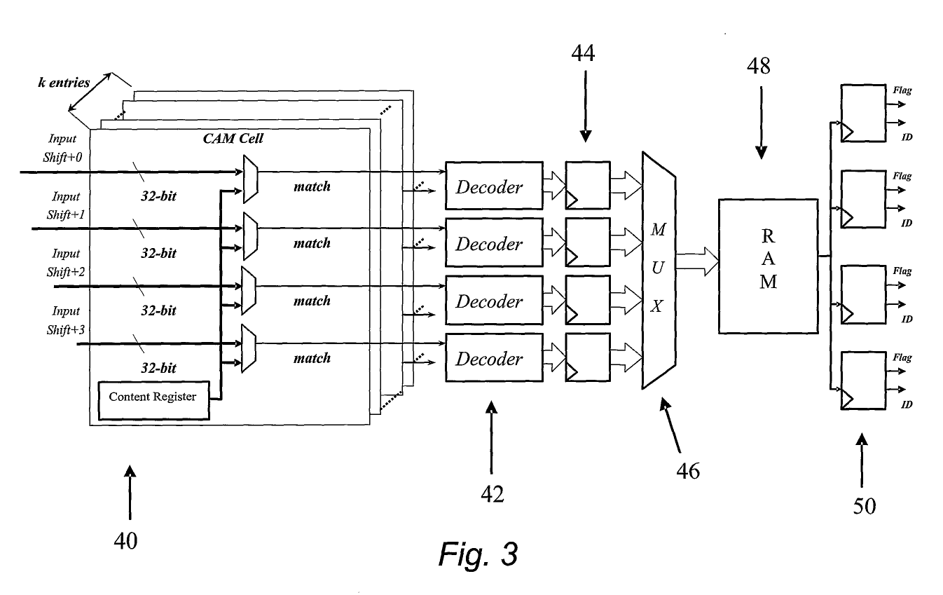

FIG. 3 is a schematic representation of part of the CAM module of FIG. 1, and

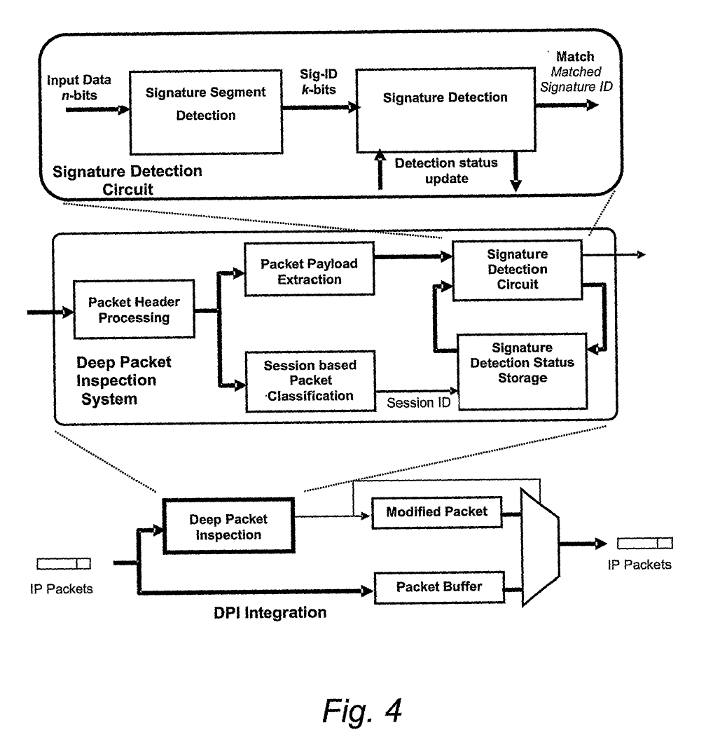

FIG. 4 is a schematic representation of a deep packet inspection system comprising a signature detection circuit of the invention.

In the embodiment described, the selected patterns comprise signatures or segments of signatures of malicious content. It will be appreciated, however, that this is only an example, and that the invention is applicable to the detection of many types of patterns.

FIG. 1 shows a pattern or signature detection circuit 1, comprising an input register 10, a hash module 12, a content addressable memory (CAM) module 14, a plurality of multiplexers 16, and a plurality of output registers 18. In this embodiment, the signature detection circuit forms part of a deep packet inspection (DPI) system of a communications network, and receives data being communicated between a plurality of entities. The data is formatted into packets, each comprising a header and a payload. It is possible that the payload of any packet may contain malicious content, such as a virus or a worm. The signature detection circuit 1 checks the data, and flags any malicious content which is found in the data to the DPI system. Malicious content, such as viruses, generally each comprise a unique identifier or signature. To date, a finite number of viruses etc, with a corresponding finite number of signatures, are known. The signature detection circuit 1 of the invention checks the data in the network for malicious content, by looking for these signatures.

The network data is input into the input register 10 of the signature detection circuit 1, and is output therefrom and processed by the circuit, in this embodiment, as a series of 4 byte data blocks. It will be appreciated, however, that other data block sizes could be used, for example 8 byte or 16 byte data blocks. Each signature of a malicious content will usually comprise a number of bytes, e.g. 1, 2, 3, 4, 6, 8, 12, 14, 16, 24 etc. Hence each signature could be spread across one or more data blocks output from the input register 10. When a signature to be detected has a length which is less than the length of the data blocks (i.e. in this embodiment, less than 4 bytes), the signature detection circuit will inspect the received data blocks for the complete signature. When, as is more often the case, a signature to be detected has a length which is greater than the length of the data blocks (i.e. in this embodiment, greater than 4 bytes), the signature detection circuit will inspect the received data blocks for segments of the signature. Information about the signatures or the signature segments which have been detected are output from the signature detection circuit 1, and, in the case of the signature segments, can be collated.

A signature or first signature segment may start at a plurality of locations in the network data. This is taken into account by configuring the signature detection circuit 1 to process blocks of data which are shifted (or offset) with respect to a first block of data, for example shifted by one or more bytes. In this embodiment, the signature detection circuit 1 processes the data by inputting a block of 4 bytes of data, for example x1, x2, x3 and x4 (shift=0), into a first hash device of the hash module 12, and also into a first CAM comparator of the CAM module 14. A next block of 4 bytes of data, shifted by 1 byte, i.e. x2, x3, x4 and x5, is input into a second hash device of the hash module 12, and also into a second CAM comparator of the CAM module 14, and so on, for each hash device of the hash module 12 and CAM comparator of the CAM module 14. The hash module 12 and the CAM module 14 both check the data blocks for malicious content. The outputs of these modules are received by the plurality of multiplexers 16, and details of any malicious content found in the data blocks output by the multiplexers 16 to the plurality of output registers 18, and from these to the communications network.

The functioning of the components of this embodiment of the signature detection circuit 1 will now be described in more detail.

FIG. 2 illustrates a part of the hash module 12, in detail. This comprises first to fourth hash devices 20, first to fourth registers 22, a multiplexer 24, a RAM device 26, first to fourth registers 28, and first to fourth comparators 30. The network data, which is to be checked for malicious content, is received by each of the hash devices 20, in blocks of 4 bytes, as illustrated.

Each hash device operates in the same way, the basic hash function of which is to receive a 4 byte (32 bit) data block, and to generate a key, the value of which depends on the value of the data block, and which key is compressed with respect to the data block, i.e. comprises less than 32 bits. In this embodiment, each key generated by a hash device has a length of 12 bits. It will be appreciated, however, that keys having bit sizes other than 12 (but less than 32) can be generated.

The use of a hash function gives rise to a high probability that two or more distinct data blocks will generate identical keys. For example, five distinct data blocks, three of which contain malicious content, and two of which do not, could generate identical keys. Such situations are referred to as collisions.

When the particular hash function to be used in the hash devices has been determined, a software module uses the hash function to generate a key for every possible 32 bit data block. This allows a table to be drawn up, having an entry for each key, comprising the value of the key and either zero or the data block or blocks which generate the key. If a key was generated by one or more data blocks each of which do not contain malicious content, the entry for the key comprises the key value and zero. If a key was generated by one or more data blocks each of which is made up of one of the known signatures or comprises a segment of one of the known signatures, i.e. contains malicious content, the entry for the key comprises the key value and the or each of the data blocks i.e. the or each of the signatures or signature segments. A signature ID or a signature segment ID, whichever is appropriate, for the or each of the data blocks is also added to the entry for the key, the use of which is described below. If a key was generated by data blocks one or more of which is made up of one of the known signatures or comprises a segment of one of the known signatures, i.e. contains malicious content, and one or more of which do not contain malicious content, the entry for the key comprises the key value and the or each of the data blocks containing malicious content, i.e. the or each of the signatures or signature segments, and a signature ID or a signature segment ID for the or each of these data blocks. The collisions which result from use of the hash function are therefore noted.

The table is then used to configure the RAM device 26 of the hash module 12. The RAM device 26 comprises a plurality of memory locations. Each memory location is assigned an address which has a value equal to one of the keys, and a content comprising either zero or one data block which generates the key, as follows. If a key was generated by one or more data blocks each of which do not contain malicious content, the content of the memory location for the key comprises zero. If a key was generated by one or more data blocks each of which is made up of one of the known signatures or comprises a segment of one of the known signatures, i.e. contains malicious content, the content of the memory location for the key comprises the or one of the data blocks i.e. the or one of the signatures or signature segments, and a signature ID or a signature segment ID. If a key was generated by data blocks, one or more of which is made up of one of the known signatures or comprises a segment of one of the known signatures, i.e. contains malicious content, and one or more of which do not contain malicious content, the content of the memory location for the key comprises the or one of the data blocks which contain malicious content, i.e. the or one of the signatures or signature segments and a signature/signature segment ID. It will be noted from the latter two situations, when a plurality of data blocks containing malicious content generate the same key, only one of the data blocks, i.e. signature/signature segment, is chosen for entry into the memory location of the RAM device. The remaining data blocks containing malicious content are used to configure the CAM module 14, as described below.

The RAM device 26 has a memory location for each distinct key value, and therefore comprises a number of memory locations equal to the number of possible keys. Each key comprises 12 bits. There are therefore 2¹² possible key values. The RAM device 26 therefore comprises 2¹² memory locations. Each key is compressed in comparison to the data block from which it was generated, i.e. each key only comprises 12 bits as opposed to the 32 bits of the data block. This results in the RAM device 26 only needing 2¹² memory locations, as opposed to 2³² memory locations that would be required if each key comprised 32 bits. Use of the hash devices to compress the data input to the signature detection circuit 1, therefore allows greatly reduced memory requirements for the RAM device 26.

In operation, the hash devices each receive a data block, and generate a key. Each hash device outputs the generated key to one of the registers 22. Each register then outputs its key to the multiplexer 24. The multiplexer 24 receives an address input (not shown) which causes it to receive a key on each of its four inputs in turn, and output the keys, in turn, to the RAM device 26.

The RAM device 26 receives the keys in turn. Each key is used as a memory location address, i.e. the value of the key is compared to the addresses of the memory locations of the RAM device 26, until a memory location is found whose address value matches the value of the key. When the matching memory location of the RAM device 26 is found, the content of the matching memory location is read. The content of the memory location will either comprise zero, or will comprise a data block which contains malicious content, i.e. a signature or signature segment, and a signature/signature segment ID. In this embodiment, as the data blocks are 32 bits long, the signature or signature segment is 32 bits long, and the signature/signature segment ID is chosen to have a length of 12 bits.

The RAM device 26 outputs the contents of the addressed memory locations in turn, to the first, then second, then third and then fourth one of the registers 28. Each of the registers 28 outputs a zero or a 12 bit signature/signature segment ID part of its received memory location content to the multiplexers 16 of the signature detection circuit 1 (see FIG. 1), for comparison with outputs of the CAM module 14, as described below.

Each of the registers 28 also outputs the 32 bit signature/signature segment part of its received memory location content to one of the comparators 30, as shown. Each comparator receives two inputs, an original data block (fed via the delay, as illustrated) and the 32 bit signature/signature segment part of the content of a memory location which results from the key generated using the same data block. Each comparator compares the value of the original data block and the value of the 32 bit signature/signature segment part of the memory location content, and outputs a match flag, which indicates that malicious content has been found, if these are found to be the same.

According to the operation of the signature detection circuit described above, if the data block does not contain malicious content, i.e. does not comprise a signature or contain a signature segment, it will generate a key which either results in a zero memory location content (when the key is generated by one or more data blocks which do not contain malicious content), or results in a memory location content comprising a 32 bit signature/signature segment (when the key is generated by one or more data blocks which do not contain malicious content and one or more data blocks which do contain malicious content). In either case, comparison of the 32 bit signature/signature segment of the memory location content with the original data block, will result in a finding that these are not the same, and no match flag will be generated, i.e. the circuit indicates that no malicious content was found in that data block. If the data block does contain malicious content, i.e. does comprise a signature or contain a signature segment, it will generate a key which either results in a memory location content comprising a 32 bit signature/signature segment equal to the signature/signature segment of the data block (when the key is generated by one or more data blocks which do contain malicious content, and this data block was chosen for entry into the RAM device), or a memory location content comprising a 32 bit signature/signature segment not equal to the signature/signature segment of the data block (when the key is generated by one or more data blocks which do contain malicious content, and this data block was not chosen for entry into the RAM device). In the first case, comparison of the 32 bit signature/signature segment of the memory location content with the original data block will result in a finding that these are the same, and a match flag will be generated i.e. the system indicates that malicious content has been found in that data block. In the second case, comparison of the 32 bit signature/signature segment of the memory location content with the original data block will result in a finding that these are not the same, and no match flag will be generated i.e. the system indicates that malicious content has not been found in that data block. This is not the correct indication, but this scenario is catered for using the CAM module 14, as described below.

The hash devices etc. illustrated in FIG. 2 comprise only a first part of the actual hash module 12 of the signature detection circuit 1. This first part of the hash module 12 is able to detect signatures or signature segments which are 4 bytes in length. The hash module 12 further comprises a second part, which is able to detect signatures or signature segments which are 3 bytes in length, by looking for signatures/signature segments in 4 byte data blocks which have possible signature data in the three most significant bytes and ‘wild-card’ data in the remaining byte. The hash module 12 further comprises a third part, which is able to detect signatures or signature segments which are 2 bytes in length, by looking for signatures/signature segments in 4 byte data blocks which have possible signature data in the two most significant bytes and ‘wild-card’ data in the remaining bytes. The hash module 12 further comprises a fourth part, which is able to detect signatures or signature segments which are 1 byte in length. The second and third parts of the hash module comprise the same components as the first part, and function in the same manner. The fourth part of the hash module comprises simply a RAM device, which is able to provide sufficient memory, without undue hardware requirements, to detect signatures or signature segments of length of 1 byte. The data blocks which are input into the first part of the hash module as described above, are also input into the second, third and fourth parts of the hash module. Such an arrangement for the hash module 12, allows this to be used to detect signatures or signature segments of variable length. For example, if a signature to be detected has a length of 4 bytes, this is fed to all parts of the hash module, and the complete signature can be detected by the first part of the hash module 12, and will not be detected by the other parts. If a signature to be detected has a length of 2 bytes, this is fed to all parts of the hash module, and the complete signature can be detected by the third part of the hash module 12, and will not be detected by the other parts. If a signature to be detected has a length of 6 bytes, as the data blocks fed to the parts of the hash module have a length of 4 bytes, a signature segment comprising the first 4 most significant bytes of the signature is fed to all parts of the hash module, and this signature segment can be detected by the first part of the hash module 12, and will not be detected by the other parts, and a signature segment comprising the remaining 2 bytes of the signature and the next 2 bytes of the input data is fed to all parts of the hash module, and this signature segment can be detected by the third part of the hash module 12, and will not be detected by the other parts. Thus both segments of the signature may be detected by the hash module 12, and output therefrom. The segments may subsequently be collated to enable raising of a flag indicating that malicious content has been detected.

As described above, as a hash function is being used in the detection of malicious content, it is likely that collisions will occur, i.e. that two or more distinct data blocks will generate identical keys. The collisions which occur for the hash function used in the hash devices are determined, and the RAM device 26 configured accordingly. When a data block which does not contain malicious content and a data block which does contain malicious content each give rise to the same key, this is of no consequence to the detection of malicious content by the signature detection circuit 1. In this case, the RAM device 26 will have been configured so that the memory location whose address is equal to the key has a content comprising details of the data block which contains the malicious content, and a match flag will be generated for the data block containing the malicious content. However, when two or more data blocks each containing malicious content each give rise to the same key, this could affect the detection of malicious content by the signature detection circuit 1. In this case, the RAM device 26 will have been configured so that the memory location whose address is equal to the key has a content comprising only one of the data blocks which contains the malicious content. As detailed above, this can give result in no match flag being generated for a data block which, in fact, contains malicious content. Such a situation is catered for by the CAM module 14.

Part of the CAM module 14 is illustrated in FIG. 3. This comprises a plurality of CAM cells 40, a plurality of decoders 42, a plurality of registers 44, a multiplexer 46, a RAM device 48, and a plurality of registers 50. Each CAM cell comprises a content register and a plurality of comparators.

The CAM cells are customised to deal with a collision of two or more data blocks containing malicious content. As stated above, the data blocks which give rise to such collisions are determined by the software module. One of the data blocks is chosen for entry in a memory location of the RAM device 26 of the hash module 12 (and hence if a data block equal to this chosen data block is input into the signature detection circuit, its malicious content will be detected). The remaining data block or blocks are catered for using one or more of the CAM cells. A CAM cell is customised to cater for one such data block, by storing the data block in the content register of the cell. The CAM module 14 will therefore comprise k CAM cells, where k equals the number of data blocks containing malicious content which are not chosen for storage in the RAM device 26 of the hash module 12.

Each CAM cell comprises four comparators. For each of the CAM cells, each of the comparators receives an input data block of the network data, shifted with respect to a first data block as detailed earlier. For each CAM cell, each comparator also receives the data block stored in the content register of the CAM cell. Each comparator compares the input data block with the content register data block, and outputs a match equal to 0 if these are not the same, or outputs a match equal to 1 if these are the same. In the latter case, this means that the input data block contains malicious content (i.e. a signature or signature segment), which is the same as one of the data blocks containing malicious content which give rise to a collision. The output of a first comparator of each of the CAM cells is input into a first decoder, the output of a second comparator of each of the CAM cells is input into a second decoder, etc., as shown. For each match equal to 1 received by a decoder, the decoder determines the identity of the CAM cell and the identity of the comparator of the CAM cell which has output the match, and outputs a binary value which indicates the location of the origin of the match. For each match equal to 0 received by a decoder, the decoder outputs a binary value of zero.

Each decoder outputs the binary location value or values and zero value or values to one of the registers 42, as shown. Each register then outputs its binary location value or values and zero value or values to the multiplexer 44. The multiplexer 44 receives an address input (not shown) which causes it to receive a binary location value or zero value on each of its four inputs in turn, and output the binary location values and zero values, in turn, to the RAM device 48.

The RAM device 48 receives the binary location values and zero values in turn. Each binary location value and zero value is used as a memory location address. When a zero value is received, this maps to a memory location of the RAM 48 whose address is equal to zero, and the content of this memory location, which is equal to zero, is output to one of the registers 50. When a binary location value is received, this is compared to the addresses of the memory locations of the RAM device 48, until a memory location is found whose address matches the binary location value. When the matching memory location of the RAM device 48 is found, the content of the matching memory location is output to one of the registers 50. The content of the memory location will comprise a 12 bit signature/signature segment ID of the data block which generated the match which generated the binary location value.

The RAM device 48 outputs the zero values and 12 bit signature/signature segment IDs in turn, to the first, then second, then third and then fourth one of the registers 50. Each of the registers 50 outputs the zero values and 12 bit signature/signature segment IDs to the multiplexers 16 (see FIG. 1), for comparison with outputs of the hash module 12, as described below.

As with the hash module 12, the CAM devices etc. illustrated in FIG. 3 comprise only a first part of the actual CAM module 14 of the signature detection circuit 1. This first part of the CAM module 14 is able to detect signatures or signature segments which are 4 bytes in length. The CAM module 14 further comprises a second part, which is able to detect signatures or signature segments which are 3 bytes in length, by looking for signatures/signature segments in 4 byte data blocks which have possible signature data in the three most significant bytes and ‘wild-card’ data in the remaining byte. The CAM module 14 further comprises a third part, which is able to detect signatures or signature segments which are 2 bytes in length, by looking for signatures/signature segments in 4 byte data blocks which have possible signature data in the two most significant bytes and ‘wild-card’ data in the remaining bytes. The CAM module 14 further comprises a fourth part, which is able to detect signatures or signature segments which are 1 byte in length. The second and third parts of the CAM module comprise the same components as the first part, and function in the same manner. The fourth part of the CAM module comprises simply a RAM device, which is able to provide sufficient memory, without undue hardware requirements, to detect signatures or signature segments of length of 1 byte. The data blocks which are input into the first part of the CAM module as described above, are also input into the second, third and fourth parts of the CAM module. Such an arrangement for the CAM module 14, allows this to be used to detect signatures or signature segments of variable length. For example, if a signature to be detected has a length of 3 bytes, this is fed to all parts of the CAM module, and the complete signature can be detected by the second part of the CAM module 14, and will not be detected by the other parts. If a signature to be detected has a length of 1 byte, this is fed to all parts of the CAM module, and the complete signature can be detected by the fourth part of the CAM module 14, and will not be detected by the other parts. If a signature to be detected has a length of 7 bytes, as the data blocks fed to the parts of the CAM module have a length of 4 bytes, a signature segment comprising the first 4 most significant bytes of the signature is fed to all parts of the CAM module, and this signature segment can be detected by the first part of the CAM module 14, and will not be detected by the other parts, and a signature segment comprising the remaining 3 bytes of the signature and the next byte of the input data is fed to all parts of the CAM module, and this signature segment can be detected by the second part of the CAM module 14, and will not be detected by the other parts. Thus both segments of the signature may be detected by the CAM module 14, and output therefrom. The segments may subsequently be collated to enable raising of a flag indicating that malicious content has been detected.

For each of the data blocks input into the signature detection circuit 1, each of the multiplexers 16 of the circuit receives a zero value or a 12 bit signature/signature segment ID from the hash module 12, a zero value or a 12 bit signature/signature segment ID from the CAM module 14 and an idle signal, as shown. Each multiplexer 16 outputs the hash 12 bit signature/signature segment ID if received, or outputs the CAM 12 bit signature/signature segment ID if received, or outputs the idle signal, if zero values are received from both the hash module 12 and the CAM module 14. The outputs of the multiplexers 16 are received by the registers 18. Each of the registers outputs either the hash 12 bit signature/signature segment ID or the CAM 12 bit signature/signature segment ID, together with a flag that indicates that malicious content has been found in a data block of the network data, or the idle value. These are output from the signature detection circuit 1 to the DPI system for use therein. As the signature/signature segment IDs have only 12 bits, as opposed to the 32 bit signature/signature segments, the IDs are more readily usable, e.g. in terms of memory required to store them, than the signature/signature segments.

In this embodiment, the signature detection circuit 1 comprises part of a DPI system, as shown in FIG. 4. The DPI system receives IP packets, as shown in the lower part of the figure. The DPI system processes the IP packets to extract the payloads therefrom, as shown in the middle part of the figure. The signature detection circuit is used to detect signatures in the payloads, as shown in the upper part of the figure. This illustrates that, when signature segments are detected, these are collated to form complete signatures to determine the presence of malicious content in the payloads.

1. A method of detecting patterns in a plurality of data blocks, comprising generating a first database comprising a first subset of patterns of a set of selected patterns, generating a second database comprising a second subset of remaining patterns of the set of selected patterns, receiving the plurality of data blocks, and, for each data block, using the data block and a hash function to generate a key, using the key to search the first database, locating an entry of the first database corresponding to the key, reading the content of the entry which comprises zero or a selected pattern that generates the key, if the content of the entry comprises zero, determining that the data block does not comprise a selected pattern, and outputting a first output indicating that the data block does not comprise a selected pattern, or if the content of the entry comprises a selected pattern, determining that the data block comprises the selected pattern and outputting a first output indicating that the data block comprises the selected pattern, or determining that the data block does not comprise the selected pattern and outputting a first output indicating that the data block does not comprise the selected pattern, and using a content addressable memory (CAM) to compare the data block with the second database, determining that the data block matches a selected pattern in the second database, and outputting a second output indicating that the data block comprises the selected pattern, or
determining that the data block does not match a selected pattern in the second database, and outputting a second output indicating that the data block does not comprise a selected pattern, combining the first and second outputs, and if either output indicates that the data block comprises a selected pattern, outputting a flag indicating that the data block comprises the selected pattern.

2. A method according to claim 1, in which generating the first database comprising the first subset of patterns of a set of selected patterns, comprises determining each possible data block, using each possible data block and the hash function to generate a plurality of keys, comparing the or each data block which generates a key with the set of selected patterns, and if the or each data block does not comprise a selected pattern, generating an entry of the first database comprising the key and zero, or if the or any of the data blocks does comprise a selected pattern, generating an entry of the first database comprising the key, the or one of the data blocks which comprises a selected pattern and an identifier (ID) for the data block.

3. A method according to claim 1, in which generating the second database comprising the second subset of remaining patterns of a set of selected patterns, comprises generating an entry of the second database comprising each of the data blocks which comprises a selected pattern not stored in an entry of the first database.

4. A method according to claim 1, in which generating the key comprises generating a key which is compressed with respect to the data block.

5. A method according to claim 1, in which determining that the data block comprises or does not comprise a selected pattern comprises comparing the data block with the selected pattern to determine if a match between them does or does not occur.

6. A method according to claim 1, which is used to detect patterns starting at any position of a data block.

7. A method according to claim 1, which is used to detect selected patterns having various lengths.

8. A method according to claim 1, in which the selected patterns comprise any of whole or partial words or whole or partial strings or whole or partial DNA sequences or signatures or signature segments of malicious content.

9. A pattern detection circuit for detecting patterns in a plurality of data blocks, comprising a plurality of hash modules, each hash module comprising a first database comprising a first subset of patterns of a set of selected patterns, wherein each hash module receives the plurality of data blocks, and, for each data block, uses the data block and a hash function to generate a key, uses the key to search the first database, locates an entry of the first database corresponding to the key, reads the content of the entry which comprises zero or a selected pattern that generates the key, if the content of the entry comprises zero, determines that the data block does not comprise a selected pattern, and outputs a first output indicating that the data block does not comprise a selected pattern, or if the content of the entry comprises a selected pattern, determines that the data block comprises the selected pattern and outputs a first output indicating that the data block comprises the selected pattern, or determines that the data block does not comprise the selected pattern and outputs a first output indicating that the data block does not comprise the selected pattern, and a plurality of CAM modules, each CAM module comprising a second database comprising a second subset of remaining patterns of the set of selected patterns, wherein each CAM module receives the plurality of data blocks, and, for each data block, compares the data block with the second database, determines that the data block matches a selected pattern in the second database, and outputs a second output indicating that the data block comprises the selected pattern, or determines that the data block does not match a selected pattern in the second database, and outputs a second output indicating that the data block does not comprise a selected pattern, and a combiner module which combines the first and second outputs, and if either output indicates that the data block comprises a selected pattern, outputs a flag indicating that the data block comprises the selected pattern.

10. A circuit according to claim 9, in which each hash module comprises a RAM device.

11. A circuit according to claim 10, in which each RAM device stores the first database.

12. A circuit according to claim 11, in which a key is used to search the first database of a RAM device by using the key as an address to search addresses assigned to a plurality of memory locations of the RAM device.

13. A circuit according to claim 9, in which each hash module comprises a plurality of hash devices each of which uses a data block and the hash function to generate a key.

14. A circuit according to claim 9, in which each CAM module comprises a plurality of CAM cells.

15. A circuit according to claim 14, in which each CAM cell stores a data block comprising a pattern of the second database.

16. A circuit according to claim 15, in which each CAM cell comprises a plurality of comparators each of which compares a received data block with the data block stored in the CAM cell.

17. A circuit according to claim 9, which detects a pattern starting at any position of a data block.

18. A circuit according to claim 17, in which the pattern detection circuit comprises a plurality of hash devices and a plurality of CAM comparators, a first data block is input into a first hash device and into a first CAM comparator, a second data block, shifted with respect to the first data block, is input into a second hash device and into a second CAM comparator and so on.

19. A circuit according to claim 18, in which the second data block is shifted by one or more positions of the block with respect to the first data block.

20. A circuit according to claim 19, in which the first and second data blocks comprise bits or bytes, and the second data block is shifted by one or more positions comprising one or more bits or bytes of the block with respect to the first data block.

21. A circuit according to claim 9, which comprises a plurality of parts, a first part which detects patterns of length n, a second part which detects patterns of length n−1, a third part which detects patterns of length n−2, and so on.

22. A circuit according to claim 9, in which the selected patterns comprise any of whole or partial words or whole or partial strings or whole or partial DNA sequences or signatures or signature segments of malicious content.
